(19) United States
(12) Patent Application Publication
(10) Pub. No.: US 2024/0090736 A1
(43) Pub. Date: Mar. 21, 2024

(54) SELF-PROPELLED FLOOR PROCESSING DEVICE WITH AN OBSTACLE DETECTION DEVICE HAVING A BUMPER AND AT LEAST ONE IMPACT SENSOR

(71) Applicant: Vorwerk & Co. Interholding GmbH, Wuppertal (DE)

(72) Inventors: Helmut SCHOENHOFF, Remscheid (DE); Utz VAHLDIEK, Schwelm (DE)

(73) Assignee: Vorwerk & Co. Interholding GmbH, Wuppertal (DE)

(21) Appl. No.: 18/369,873

(22) Filed: Sep. 19, 2023

(30) Foreign Application Priority Data
Sep. 21, 2022 (EP) 22196756.5

(51) Int. Cl. A47L 11/40; A47L 9/28

(52) U.S. Cl. CPC A47L 11/4061; A47L 9/2805; A47L 2201/04

(57) ABSTRACT

A self-propelled floor processing device includes a base body, a driving device, and an obstacle detection device for detecting a collision between the floor processing device and an obstacle, wherein the obstacle detection device has a bumper arranged in a protruding position on the base body, as well as at least one impact sensor allocated to the bumper. The impact sensor is configured to detect a displacement of the bumper relative to the base body. In order to create an obstacle detection device that functions optimally independently of a position and direction of a force acting from outside, the bumper is mounted to the base body via at least one swivel joint.

### CROSS REFERENCE TO RELATED APPLICATIONS

Applicant claims priority under 35 U.S.C. § 119 of European Application No. 22196756.5 filed Sep. 21, 2022, the disclosure of which is incorporated by reference.

### BACKGROUND OF THE INVENTION

### 1. Field of the Invention

The invention relates to a self-propelled floor processing device with a base body, a driving device, and an obstacle detection device for detecting a collision between the floor processing device and an obstacle, wherein the obstacle detection device has a bumper arranged in a protruding position on the base body, as well as at least one impact sensor allocated to the bumper, wherein the impact sensor is configured to detect a displacement of the bumper relative to the base body.

### 2. Description of the Related Art

Self-propelled floor processing devices are sufficiently known in prior art. In particular, the latter have a navigation device, which serves to navigate and self-localize the floor processing device within an environment. For example, the navigation device can have a contactless distance measuring device, which measures distances to obstacles. Based on the measured distances, an area map is generated, in which obstacle data are stored. The area map is subsequently used by the floor processing device for navigation and self-localization.

In addition, known floor processing devices have a bumper, also referred to as bumper, which is arranged in a protruding position on a base body of the floor processing device, and is displaced relative to the base body upon contact with an obstacle. The bumper has allocated to it at least one impact sensor, which detects the displacement of the bumper.

It is further known to arrange the bumper in a U-shaped manner on an outer contour of the base body of the floor processing device, wherein the bumper essentially follows the outline of the floor processing device. The U shape thus yields a bumper area which is allocated to a base body front, and bumper areas which are allocated to at least partial areas of two opposing base body sides. This makes it possible to detect both frontal and lateral collisions with obstacles.

For example, known from DE 10 2013 107 160 A1 is a self-propelled floor processing device in which a pushbutton element is arranged on the device by means of a linear bearing. In addition, the pushbutton element consists of an elastically resettable material, so that stressing the pushbutton element outside of the direction of movement of the linear bearing can lead to a deformation of the pushbutton element, for example to a parallelogram-type shifting of a U-leg relative to a U-web. Accordingly, forces acting on the pushbutton element opposite or at least approximately opposite the usual traversing direction are acquired by the movement by at least one U-leg of the pushbutton element, while forces acting transverse to the usual traversing direction, i.e., laterally acting forces, lead to a component deformation of the latter. A combination of displacement and component deformation is also possible, depending on the location of force exposure.

Depending on the position and direction of the forces acting from outside, the linearly guided bearing of the pushbutton element on the base body gives rise to tilting moments on the pushbutton element that can lead to skewing or canting. This produces elevated frictional forces, so that correspondingly larger activating forces are required for activating the impact sensor. As a consequence, impacts on the pushbutton element might under certain circumstances not be optimally detected by the sensor system. In addition, reduced working strokes can result, caused by a nonuniform displacement of the pushbutton element relative to the device base body. As a whole, then, the sensitivity of the impact sensor is reduced.

### SUMMARY OF THE INVENTION

Proceeding from the aforementioned prior art, the object of the invention is therefore to design a floor processing device with an obstacle detection device that functions reliably independently of a position and direction of impact forces acting from outside, and has an optimal sensor sensitivity.

To achieve the aforementioned object, it is proposed that the bumper be mounted to the base body via at least one swivel joint.

Contrary to prior art, then, the bumper according to the invention is no longer arranged on the base body with bearings for parallel guidance, but rather mounted to the base body via a swivel joint. Due to the tilt-resistant and low-friction bearing via the swivel joint, it is sufficient that one or several impact sensors be arranged in just a single plane in order to be able to detect impacts on all planes of the bumper with enough sensitivity. The use of a swivel joint results in a uniform movement in the different planes of the swivel joint, so that the working strokes are uniform, and collisions with obstacles can be detected with an identical sensitivity, independently of a position and direction of the acting force. In addition, it is not required—or is even disadvantageous—that the bumper be designed using an elastically resettable material in order to detect transverse impacts, transverse to a usual direction of movement of the floor processing device. Rather, a material with a high hardness level is recommended in terms of the invention, so as to support the function of the obstacle detection device and sensibly complement the tilting rigidity of the swivel joint. Last but not least, the use of a swivel joint also reduces the installation space required for the mechanics or bearing of the bumper. It is especially advantageous that the length of a joint axis of the swivel joint essentially be the same as the height of the bumper in design.

It is further proposed that the swivel joint have a joint axis oriented essentially perpendicular to the surface in a state of the floor processing device where it is traveling on a surface to be processed. The essentially vertical orientation of the joint axis of the swivel joint allows the bumper to be displaced parallel to the surface on which the floor processing device travels or stands, while no degree of freedom is given perpendicular thereto, i.e., in the direction of the longitudinal extension of the joint axis. As a whole, then, this yields a movability of the bumper in a plane parallel to the direction of movement of the floor processing device, wherein directional components can also add up in the direction of movement and transverse direction to a resultant vector in this plane. The movability of the bumper with the help of the swivel joint preferably measures at least 5 mm in the direction of movement or transverse thereto (in the same horizontal plane of the floor processing device). The same holds true for the resultant vector in the diagonal direction. The bumper requires no additional horizontal support surfaces apart from the relatively small axial support surfaces of the swivel joint in order to position the bumper in a perpendicular location. During exposure to a load (tilting moments), the forces are predominantly guided via the radial bearing surfaces of the swivel joint into the base body of the floor processing device. This yields favorable sliding bearing conditions on small effective diameters, which can be easily realized by using standard elements, and require no special precision.

It is provided that the swivel joint have two connecting areas lying radially opposite each other in relation to the joint axis, of which a first connecting area is rotatably arranged on the base body, and of which a second connecting area is rotatably arranged on the bumper. In addition to the movability of the bumper via the joint axis of the swivel joint, then, two additional rotational axes arise on the swivel joint around which the bumper can be moved. As a whole, the bumper is resultantly mounted to the base body via three rotational axes, and displaceable relative thereto. The rotational movements here take place in only a single horizontal plane, preferably parallel to the surface to be processed, on which the floor processing device is moving. The rotational axes of the swivel joint and their connecting areas are arranged in such a way that they cannot be positioned along a single line. This means that a stretched position with three rotational axes located on one line is not possible within the framework of the range of movement. As a consequence, only clear angular positions of the bumper are possible, which only permit clear detection signals of the impact sensor within its working area. The bearing system thus consists essentially of three partial areas, which are each connected by a rotational axis, specifically the fixed base body of the floor processing device, the swivel joint rotatably connected with the base body via a first rotational axis and the first connecting area, and the bumper connected via a second rotational axis and the second connecting area of the swivel joint, which acts on the at least one impact sensor.

In this conjunction, it can be provided in particular that the respective connecting area be connected with the base body or the bumper via a connecting means that forms a rotational axis, wherein the connecting means is oriented parallel to the joint axis of the swivel joint. The proposed connecting means here serve first to fasten the swivel joint to the base body on the one hand and to the bumper on the other, and second to provide two additional rotational axes for the movability of the bumper in addition to the joint axis of the swivel joint, so that the bumper as a whole is mounted to the base body via three rotational axes. It is proposed that the connecting means be oriented parallel to the joint axis of the swivel joint, but in such a way that these three joints cannot be arranged on a single line. A displacement of one or several of the rotational axes in the direction of a longitudinal extension is blocked. As a consequence, the bumper can essentially only be displaced parallel to a surface on which the floor processing device is moving, and only in a single plane. The tilting rigidity of the bumper bearing described above is hence reliably reached.

It is proposed that the connecting means be a screw, a cylinder pin or a rivet. Such connecting means with a longitudinal extension that is large relative to a cross sectional measure are suitable in particular for providing a rotational axis while simultaneously attaching the swivel joint or the connecting areas to the base body or the bumper.

It is additionally proposed that the bumper be arranged on the base body via a carrier body. The floor processing device or its base body thus has a carrier body, on which the bumper is arranged, and which movably supports the bumper via the swivel joint. The carrier body itself is preferably firmly attached with the base body. The carrier body can perform several functions, which go beyond merely supporting the bumper on the base body. On the one hand, the support body makes it possible to activate the at least one impact sensor, while on the other the carrier body can also accommodate partial areas of the swivel joint. The carrier body—as the bumper itself—especially preferably has a shape that is adjusted to the outline of the base body, in particular the outline section of the base body pointing forward in the direction of movement. The carrier body especially preferably has an essentially U-shaped section. This gives rise to partial areas of the carrier body which, apart from a front region pointing forward in the direction of movement, also comprise lateral partial areas relative thereto. The U-shaped outline design of the carrier body results in a U-web that preferably extends transverse to the usual direction of movement of the floor processing device, and further preferably is formed over an entire width of the base body viewed transverse to the usual direction of movement, and two U-legs that each adjoin the U-web on the end side, and are aligned essentially parallel to the direction of movement. The U-web is connected with the U-legs with the formation of a respective corner area.

In particular, it is proposed that the carrier body have a recess for accommodating the swivel joint. In particular, the recess can be bordered by the bumper with the bumper connected with the carrier body. The recess of the carrier body is preferably located at the corner areas, at which the U-legs meet with the U-web of a U-shaped carrier body. Each corner area of the U-shaped carrier body thus has allocated to it a recess, in which a respective swivel joint can be accommodated, and through which the swivel joint can be connected with the base body on the one hand and with the bumper on the other. The recess can preferably have a triangular cross section relative to a section parallel to a movement plane of the floor processing device, wherein a first wall of the recess is formed by the material of the U-leg, and wherein a second wall is formed by the material of the adjoining U-leg. The two walls are oriented nonparallel to each other, thereby yielding the triangular shape. The third side of the triangle formed in this way is preferably open on the side pointing toward the bumper, so that the swivel joint can be easily accommodated. The size and shape of the recess along with the size and shape of the swivel joint are especially preferably adjusted to each other in such a way that the recess can be sealed on the front side by the bumper when the bumper is connected with the swivel joint, and thus also the carrier body or the base body.

The swivel joint can be connected with the base body with the carrier body interspersed, wherein a connecting means that connects a first connecting area of the swivel joint with the base body simultaneously connects the carrier body with the base body. As a consequence, the connecting means that connects the swivel joint or its first connecting area with the base body, and thus supports the swivel joint on the base body, simultaneously also serves to fasten the carrier body to the base body.

In this conjunction, it is further proposed that the bumper have a movement distance to the base body of the floor processing device with respect to a horizontal plane of the floor processing device. This can be achieved by correspondingly arranging the carrier body, wherein the carrier body provides the range of movement for the bumper, for example by virtue of the carrier body keeping a certain distance to the base body. This movement distance allows the swivel joint to be movable, and thus the bumper to be displaced in the direction of movement of the floor processing device or in a direction transverse thereto. In particular, the carrier body can be displaced proceeding from a starting position spaced apart relative to the base body into a switching position approximating the base body. Reset elements are preferably provided between the base body and the carrier body for this purpose, which displace the carrier body back into the starting position proceeding from the switching position in the absence of a force acting from outside, which arises during a collision between the floor processing device and an obstacle. This will be covered in more detail later on.

The bumper and/or the carrier body can preferably be U-shaped in design, as described previously, wherein the bumper and/or the carrier body encloses a base body front and at least partial areas of two base body sides adjoining the base body front in a respective corner area of the base body in relation to a usual direction of movement of the floor processing device, and wherein each corner area of the base body has allocated to it a swivel joint, so that the bumper can be displaced in a single plane oriented parallel to the surface to be processed, both parallel to the usual direction of movement, and also transversely thereto relative to the base body and/or the carrier body. As explained previously, the swivel joint allocated to the respective corner area of the base body can be accommodated in a recess of the carrier body. However, if no carrier body is used, the swivel joint can alternatively also be arranged directly on the base body.

Finally, it is proposed that the base body, the bumper and/or the carrier body have at least one spring element, the reset force of which tries to space the bumper apart from the base body. In particular, it is recommend that the reset system for the bumper be arranged on the base body. The reset system can have one or several spring elements, wherein a roughly uniform distribution of the spring elements over the contour of the base body is recommended, specifically in the area where the carrier body or bumper acts on the base body given a displacement of the bumper by a collision with an obstacle. In particular, it is proposed that the one or the several spring elements be designed as compression springs. The spring element is used to set the starting position of the bumper, in which the bumper is not exposed to any force from a collision with an obstacle. Spring elements for laterally centering the bumper relative to the base body are preferably also provided, for example two spring elements arranged laterally on the base body, and three spring elements frontally arranged on the base body. The three frontal spring elements are preferably arranged symmetrically along the base body front.

The mechanical stops for the bumper in the starting position or switching position are preferably not realized in the swivel joint, but rather at another location of the floor processing device, for example on the bumper and/or the base body itself.

For purposes of optimal obstacle detection, it is further recommended that several impact sensors be arranged on the base body, in particular four or more impact sensors. The impact sensors can be contact sensors, optical sensors, magnetic sensors, or capacitive sensors. One embodiment provides a contact sensor, for example an electronic pushbutton, which is contacted during the displacement of the bumper relative to the base body or carrier body. In another embodiment, an impact sensor can also involve an inductive, capacitive, magnetic, or optical proximity sensor. Light barriers, ultrasound sensors or electromagnetic proximity switches are further also possible. In particular, the impact sensors or their action field reaches through the carrier body. An action field, for example an optical, magnetic, inductive, or capacitive action field, can penetrate the carrier body, and thereby detect a displacement of the bumper inside of this action field and relative to the carrier body or base body.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a floor processing device in a three-dimensional view;

FIG. 2 is a partial area of the floor processing device with a base body, a bumper, and a carrier body for the bumper;

FIG. 3 is a section of a partial area of the floor processing device in the area of the bumper;

FIG. 4 is the base body of the floor processing device;

FIG. 5 is the carrier body of the floor processing device;

FIG. 6 is a swivel joint for supporting the bumper;

FIG. 7 is a swivel joint in a different view;

FIG. 8 is the carrier body with swivel joint arranged thereon;

FIG. 9 is the bumper from outside; and

FIG. 10 is the bumper from inside with swivel joint arranged thereon.

### DETAILED DESCRIPTION OF PREFERRED EMBODIMENTS

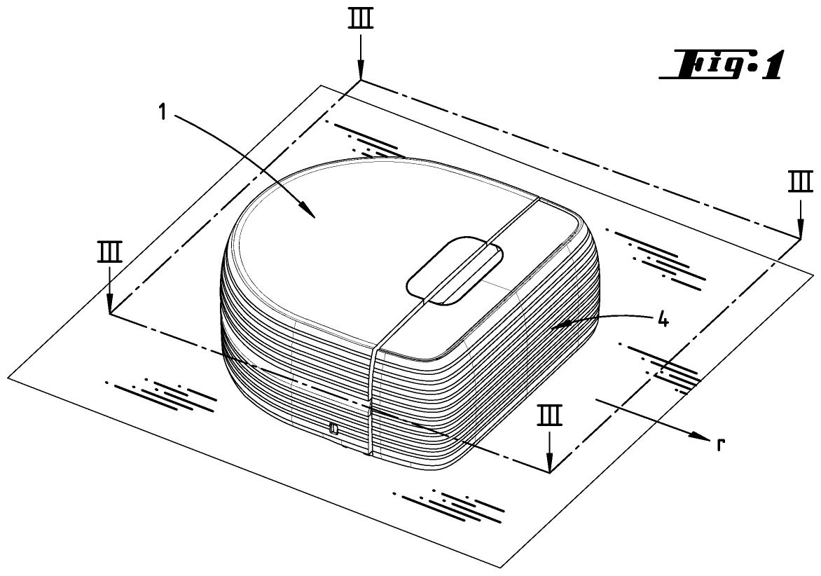

FIG. 1 shows an exemplary floor processing device 1 according to the invention. The floor processing device 1 is a self-propelled floor processing device 1. For example, it can be designed as a cleaning device, polishing device, grinding device, or the like. Examples of cleaning devices include vacuuming devices or wipe cleaning devices. The self-propelled floor processing device 1 has a driving device with an electric motor and wheels driven by the latter, and preferably a navigation device, which the floor processing device 1 can use to navigate within an environment and localize itself. For example, the navigation device has a contactless distance measuring device, which can be used to measure distances to obstacles in the environment. For example, the distance measuring device can be an optical measuring device, in particular a triangulation measuring device. Based on the detected distance values, a control and evaluation device of the floor processing device 1 generates an area map, which the floor processing device 1 can use to localize and navigate itself. The floor processing device 1 usually moves through the environment in a direction of movement r.

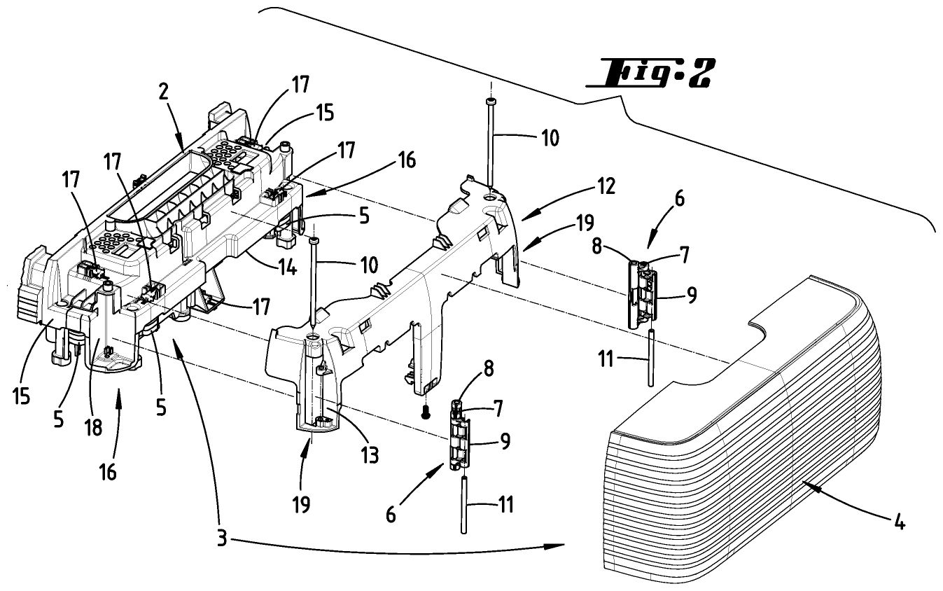

According to FIG. 2, the floor processing device 1 has a base body 2 with an obstacle detection device 3, which can be used to detect collisions between the floor processing device 1 and an obstacle in the environment. The obstacle detection device 3 has a bumper 4 arranged on the base body 2, as well as at least one impact sensor 5 allocated to the bumper 4. The bumper 4 is arranged in a protruding position on the base body 2, so that the latter runs ahead in the direction of movement r. The bumper 4 is spaced a distance apart from the base body 2, so that the bumper 4 can be displaced proceeding from a starting position into a switching position if it hits an obstacle. The at least one impact sensor 5 allocated to the bumper 4 is configured to detect a displacement of the bumper 4, specifically a displacement relative to the base body 2.

For example, the impact sensor 5 can be a contact sensor, optical sensor, inductive sensor, magnetic sensor, or capacitive sensor. According to the design shown here, the impact sensors 5 involve contact sensors, for example, which form a switch sensor system comprised of several switching elements, and are arranged along a base body front 14 and two base body sides 15 of the floor processing device 1.

If the floor processing device 1 is here designed as a vacuuming device, for example, the latter can have one or several cleaning brushes on the underside of the base body 2, for example, a brush that rotates around a vertical axis, as well as a brush that rotates around a horizontal axis. These are used to brush the surface to be cleaned, and possibly also to clean transitional areas between a floor surface and an adjoining wall area. The dirt loosened by the brush is preferably fed to a suction channel, and above that to a suction chamber, which can be emptied by a user of the floor processing device 1. The suction air streaming in the suction channel during suction operation is generated by means of a suction fan integrated into the floor processing device 1. An accumulator is used to supply power to the allocated electric motor, as well as to additional electrical consumers of the floor processing device 1.

For example, the floor processing device 1 here has an outline which in relation to the usual direction of movement r consists of a rear, semicircular partial area and a front, rectangular partial area. As a whole, this provides a device width viewed transverse to the usual direction of movement r that approximately corresponds to the length of the floor processing device 1 viewed in the direction of movement r. In opposing corner areas 16 of the base body 2 where the base body front 14 transitions into the base body sides 15, the bumper 4 is supported on the base body 2, specifically with a carrier body 12 interspersed, as will be described below.

FIG. 2 shows a detailed, exploded view of a frontal partial area of the floor processing device 1 with the base body 2, the bumper 4 and the carrier body 12 for supporting the bumper 4 on the base body 2. Further shown are two swivel joints 6, which support the bumper 4 on the base body 2.

Each swivel joint 6 has a joint axis 7 as well as a first connecting area 8 for connection with the base body 2 and a second connecting area 9 for connection with the bumper 4. The first connecting area 8 is connected with the base body 2 using a connecting means 10, which is here designed as a screw, with the carrier body 12 interspersed. The second connecting area 9 is connected with the bumper 4 via a connecting means 11, which is here designed as a cylinder pin. Other connecting means 11 are also conceivable.

The carrier body 12 arranged on the base body 2 by means of the connecting means 10 has recesses 13 for accommodating a respective swivel joint 6. The recesses 13 are located at corner areas 19 of the carrier body 12. The base body 2 likewise has recesses 18 at its corner areas 6, in which the respectively allocated recess 13 of the carrier body 12 along with the swivel joint 6 placed therein can be arranged.

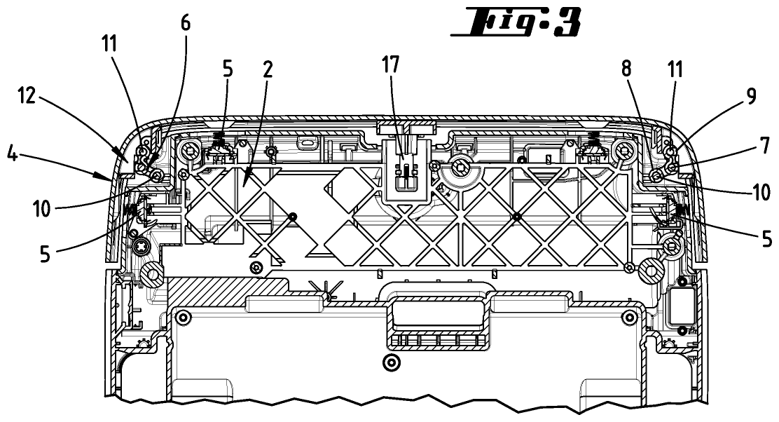

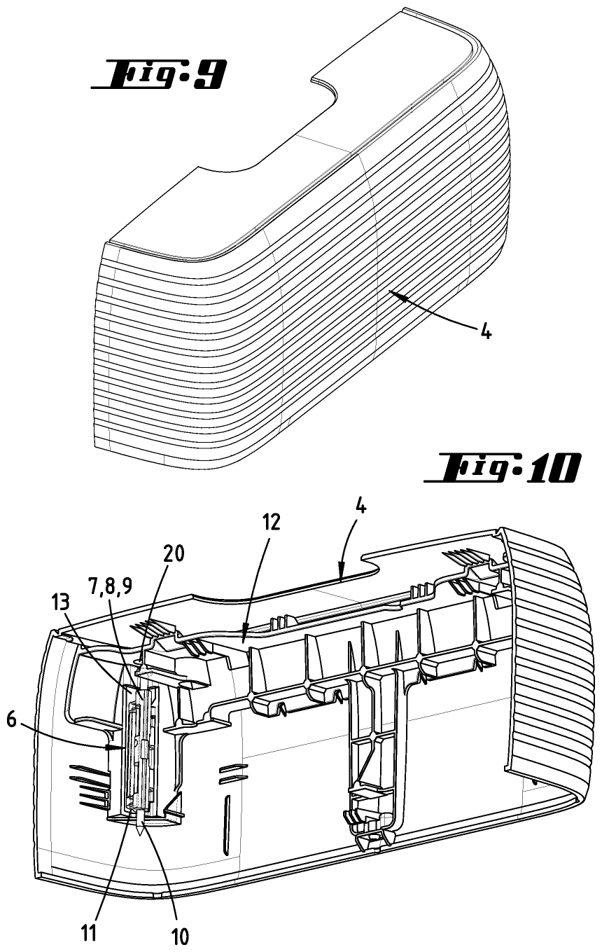

During the assembly of the floor processing device 1, the base body 2 and the carrier body 12 are aligned relative to each other via the corresponding recesses 13, 18. The swivel joint 6 is placed into the recess 13 of the carrier body 12, and hence also into the recess 18 of the base body 2, and connected with the base body 2 via the first connecting area 8 of the swivel joint 6 by means of the connecting means 10, with penetration of the carrier body 12. The connecting means 10 here forms a rotational axis, around which the first connecting area 8 of the swivel joint 6, and hence also the entire swivel joint 6, can rotate inside of the recesses 13, 18. The second connecting area 9 of the swivel joint 6 is preferably connected with an inner side of the bumper 4 that faces the carrier body 12, and penetrated by the connecting means 11. The connecting means 11 designed as a cylinder pin serves as a rotational axis for the swivel joint 6 or the bumper 4. The joint axis 7 and the rotational axes formed by the connecting means 10, 11 are oriented parallel to each other, and essentially have a length corresponding to a height of the carrier body 12 or the bumper 4 (orthogonal to a surface to be cleaned on which the floor processing device 1 is standing or traveling). Therefore obtained as a whole is a movability of the bumper 4 relative to the base body 2 over three rotational axes, which are allocated to the connecting means 10, 11 and the joint axis 7 of the swivel joint 6. In addition to the exploded view on FIG. 2, FIG. 3 shows the assembled state of the individual parts. FIGS. 4 to 10 further show individual views of the base body 2, the carrier body 12, the bumper 4 as well as the swivel joint 6.

Supporting the bumper 4 by means of a swivel joint 7 as described above enables a movability of the bumper 4 of preferably at least 5 mm in the longitudinal direction and transverse direction of the floor processing device 1, as well as diagonally in the direction of a resultant vector comprised of longitudinal and transverse movement, wherein the movements take place in the same plane. The swivel joint 6 provides a tilt-resistant support of the bumper 4 on the base body 2, so that impacts by obstacles against the bumper 4 at different height levels of the bumper 4 lead to an equivalent activation of the impact sensor 5 or the several impact sensors 5. The formation of the swivel joint 6 prevents the bumper 4 from tilting in the direction of the surface on which the floor processing device 1 is standing or traveling. This means that the joint axis 7 as well as the connecting means 10, 11 always retain their orthogonal orientation relative to the surface. As a result, the obstacle detection device can operate flawlessly, for example even when impacts take place on partial areas of the bumper 4 that lie at height levels above a height level of the impact sensor 5. A skewing or canting of the bumper 4 against the base body 2 is thus likewise prevented. Independently of the position and direction of the impact forces acting on the bumper 4 from outside, an impact on the bumper 4 can always be reliably detected by the sensor system.

Given contact with an obstacle, the swivel joint 6 according to the invention can be used to displace the bumper 4 from a starting position, in which the bumper 4 is spaced a fixed distance apart from the base body 2 or carrier body 12, into a switching position, wherein once the latter has been reached, the bumper 4 gets into the detection area of the impact sensors 5. For example, if the impact sensors 5 are contact sensors, the bumper 4 contacts the impact sensors 5 in the switching position. Based on the detection signal of the impact sensors 5, the control and evaluation device of the floor processing device 1 detects the contact between the bumper 4 and an obstacle, and initiates a stop and possible reversal of the floor processing device 1 relative to the obstacle.

As evident in particular from FIG. 4, several spring elements 17 are arranged on the base body 2, which cause the bumper 4 to be reset from the switching position into the starting position. For example, five spring elements 17 are here provided, of which three act in the direction of movement r of the floor processing device 1, and two in a direction transverse to the direction of movement r. The spring elements 17 facing in the direction of the base body sides 15 further serve to center the bumper 4 on the base body 2 or the carrier body 12 arranged thereon. For example, the spring elements 17 are here designed as compression springs. The spring-reset system formed in this way presses the bumper 4 in the direction of movement r against a mechanical stop (not shown in any greater detail), which is not allocated to the swivel joint 6, but rather realized at another location of the system. Apart from the relatively small axial support surfaces of the swivel joint 6, the bumper 4 requires no additional horizontal support surfaces in order to position the bumper 4 in a vertical position and be able to absorb impact forces or tilting moments. The impact forces are predominantly released to the base body 2 of the floor processing device 1 via the radial bearing surfaces of the swivel joint 6. As a whole, this produces favorable plain bearing conditions.

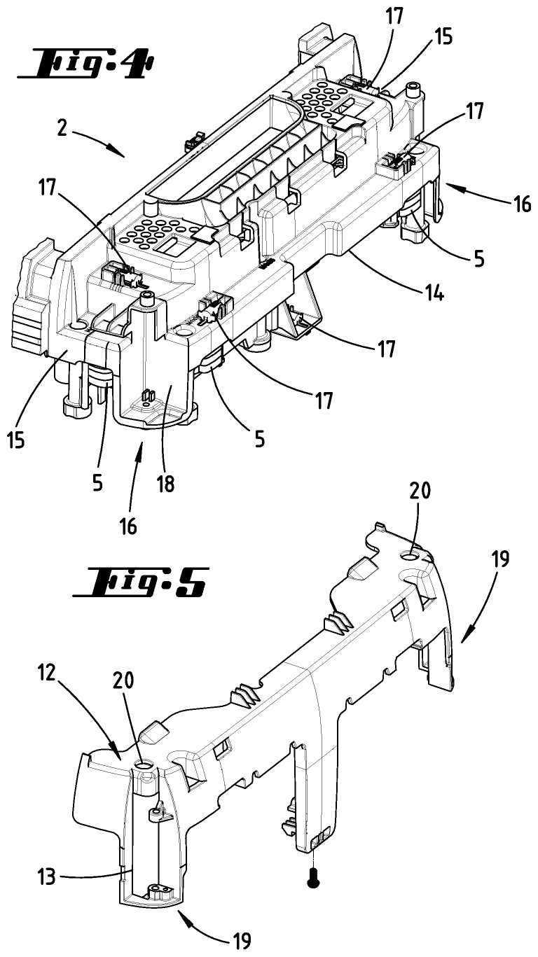

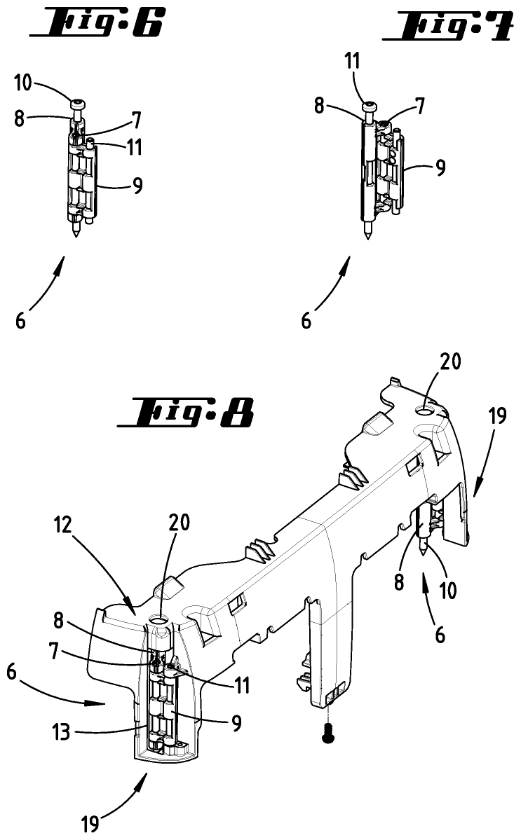

FIGS. 6 and 7 show the swivel joint 6 from two opposite perspectives. As explained previously, the swivel joint 6 has a central joint axis 7, on which the first connecting area 8 and the second connecting area 9 are rotatably mounted. Each of the connecting areas 8, 9 further serves to accommodate a connecting means 10, 11. For example, the connecting areas 8, 9 can as shown have through openings or even grooves for this purpose, through which the respective connecting means 10, 11 can be inserted.

FIG. 8 shows an arrangement of a swivel joint 6 in a corner area 19 of the carrier body 12. The swivel joint 6 is here completely accommodated in the recess 13 of the carrier body 12. In this position, the connecting means 10 can be passed through a corresponding opening 20 of the carrier body 12 and connected with the first connecting area 8 of the swivel joint 6. The second connecting area 9 is connected in the same manner with corresponding counter-elements on an interior side of the bumper 4 by means of the connecting means 11—as shown on FIG. 10.

Although only a few embodiments of the present invention have been shown and described, it is to be understood that many changes and modifications may be made thereunto without departing from the spirit and scope of the invention.

Reference List

| | |
|---|---|
| 1 | Floor processing device |
| 2 | Base body |
| 3 | Obstacle detection device |
| 4 | Bumper |
| 5 | Impact sensor |
| 6 | Swivel joint |
| 7 | Joint axis |
| 8 | First connection area |
| 9 | Second connection area |
| 10 | Connecting means |
| 11 | Connecting means |
| 12 | Carrier body |
| 13 | Recess |
| 14 | Base body front |
| 15 | Base body side |
| 16 | Corner area |
| 17 | Spring element |
| 18 | Recess |
| 19 | Corner area |
| 20 | Opening |
| r | Direction of movement |

What is claimed is:

1. A self-propelled floor processing device (1) comprising:
a base body (2),
a driving device and
an obstacle detection device (3) configured for detecting a collision between the floor processing device (1) and an obstacle,
wherein the obstacle detection device (3) has a bumper (4) arranged in a protruding position on the base body (2), as well as at least one impact sensor (5) allocated to the bumper (4), wherein the impact sensor (5) is configured to detect a displacement of the bumper (4) relative to the base body (2),
wherein the bumper (4) is mounted to the base body (2) via at least one swivel joint (6),
wherein the swivel joint (6) has a joint axis (7) oriented substantially perpendicular to s surface to be processed in a state of the floor processing device (1) where it is traveling on the surface to be processed, wherein the swivel joint (6) has two connecting areas (8, 9) lying radially opposite each other in relation to the joint axis (7), of which a first connecting area (8) is rotatably arranged on the base body (2), and of which a second connecting area (9) is rotatably arranged on the bumper (4), and
wherein the bumper (4) is arranged on the base body (2) via a carrier body (12) having a recess (13) configured for accommodating the swivel joint (6).

2. The floor processing device (1) according to claim 1, wherein each connecting area (8, 9) is connected with the base body (2) or the bumper (4) via a connecting means (10, 11) that forms a rotational axis, wherein the connecting means (10, 11) is oriented parallel to the joint axis (7) of the swivel joint (6).

3. The floor processing device (1) according to claim 2, wherein the connecting means (10, 11) is a screw, a cylinder pin or a rivet.

4. The floor processing device (1) according to claim 1, wherein the recess (13) is bordered by the bumper (4) with the bumper (4) connected with the carrier body (12).

5. The floor processing device (1) according to claim 1, wherein the swivel joint (6) is connected with the base body (2) with the carrier body (12) interspersed, wherein a connecting means (10) that connects a first connecting area (8) of the swivel joint (6) with the base body (2) simultaneously connects the carrier body (12) with the base body (2).

6. The floor processing device (1) according to claim 1, wherein at least the bumper (4) or at least the carrier body (12) is U-shaped in design, and encloses a base body front (14) and at least partial areas of two base body sides (15) adjoining the base body front (14) in a respective corner area (16) of the base body (2) in relation to a usual direction of movement (r) of the floor processing device (1), and wherein the at least one swivel joint (6) comprises two swivel joints allocated one each to the corner areas (16) of the base body (2), so that the bumper (4) can be displaced in a single plane oriented parallel to the surface to be processed, both parallel to the usual direction of movement (r), and also transversely thereto relative to the base body (2) or the carrier body (12).

7. The floor processing device (1) according to claim 1, wherein at least one of the group of base body (2), bumper (4) or carrier body (12) has at least one spring element (17), a reset force of which tries to space the bumper (4) apart from the base body (2).
